(19) United States
(12) Patent Application Publication
(10) Pub. No.: US 2013/0267241 A1
(43) Pub. Date: Oct. 10, 2013

(54) METHOD AND APPARATUS FOR COORDINATING INTERCELL INTERFERENCE

(71) Applicant: Electronics and Telecommunications Research Institute, (US)

(72) Inventors: Young Seok BAEK, Daejeon (KR); Bon Tae Koo, Daejeon (KR)

(73) Assignee: Electronics and Telecommunications Research Institute, Daejeon (KR)

(21) Appl. No.: 13/861,374

(22) Filed: Apr. 11, 2013

(30) Foreign Application Priority Data
Apr. 7, 2012 (KR) 10-2012-0039724

(51) Int. Cl. H04W 72/08

(52) U.S. Cl. CPC H04W 72/087
USPC 455/452.2

(57) ABSTRACT

A method for coordinating intercell interference and a wireless communication system are disclosed. The method includes calculating, by a first device, a beamforming vector, transmitting a signal to a first terminal using the beamforming vector calculated by the first device, receiving, by the first device, Quality of Service (QoS) information equivalent to the signal transmitted from the first terminal, and determining whether the QoS information received by the first device satisfies a predetermined first criterion and transmitting information indicating whether QoS is satisfied to a first base station.

### CLAIM FOR PRIORITY

This application claims priority to Korean Patent Application No. 10-2012-0039724 filed on Apr. 17, 2012 in the Korean Intellectual Property Office (KIPO), the entire contents of which are hereby incorporated by reference.

### BACKGROUND

1. Technical Field

Example embodiments of the present invention relate in general to a technology for coordinating intercell interference of a wireless communication system, and more specifically, to a method for coordinating intercell interference that may be applied to a heterogeneous network environment in which a large-power cell and a small-power cell are overlapped, and a wireless communication system performing the method.

2. Related Art

In a 3^{rd} Generation Partnership Project Long Term Evolution (3GPP LTE) system, standardization of releases 8 and 9 has been currently completed, and standardization of release 10 referred to as an LTE-Advanced system is now underway.

The LTE system may define heterogeneous network nodes for expansion of cell coverage and increase in cell capacity. That is, in the LTE system, a relay node, a picocell, and a femto-cell are defined as the heterogeneous network node.

The femto-cell among the above-described heterogeneous network nodes is configured in such a manner that a femto-cell base station is connected to an Internet Protocol (IP)-based broadband network within home or small business, and therefore users may freely use wired/wireless communication using mobile terminals, and communication providers may transmit mobile communication data directly to the femto-cell from the base station without using indoor relay nodes. As a result, it is possible to reduce costs for built-up of the network and reduce loads of frequencies.

Meanwhile, in the heterogeneous network environment, a macro base station (eNB) that is a large-power base station and a femto-cell base station (HeNB: Home eNB) may be installed so as to be adjacent to each other or overlapped with each other. For example, the femto-cell base station may be overlapped within a service coverage of the macro base station.

As described above, when the macro base station and the femto-cell base station are overlapped with each other and perform communication with each mobile terminal thereof using the same wireless resource, a mobile terminal located in the boundary of a macro-cell and a femto-cell may be interfered by signals transmitted from a base station of a communicating party that is not the mobile terminal's own serving base station, and therefore Quality of Service (QoS) may be deteriorated.

### SUMMARY

Accordingly, example embodiments of the present invention are provided to substantially obviate one or more problems due to limitations and disadvantages of the related art.

Example embodiments of the present invention provide a method for coordinating intercell interference that may mitigate intercell interference in a heterogeneous network environment.

Example embodiments of the present invention also provide a wireless communication system that may mitigate intercell interference in a heterogeneous network environment.

In some example embodiments, a method for coordinating intercell interference between a first cell operated by a first device and a second cell operated by a second device, the method including: calculating, by the first device, a beamforming vector; transmitting a signal to a first terminal using the beamforming vector calculated by the first device; receiving, by the first device, Quality of Service (QoS) information equivalent to the signal transmitted from the first terminal; and determining whether the QoS information received by the first device satisfies a predetermined first criterion and transmitting information indicating whether QoS is satisfied to a first base station.

Here, the calculating may include calculating a Maximum Ratio Transmission (MRT) vector only using channel information between the first device and the first terminal except information of a channel in which interference is caused by the first device.

In addition, the first cell may be disposed so as to be overlapped with the second cell, and the first device may operate the first cell with a power lower than that of the second device.

In addition, the receiving may include receiving at least one of received single-to-noise ratio (SNR) information and an amount of data transfer from the first terminal.

In other example embodiments, a method for coordinating intercell interference between a first cell operated by a first device and a second cell operated by a second device, the method including: calculating, by the second device, a beamforming vector; transmitting a signal to a second terminal using the beamforming vector calculated by the second device; receiving, by the second device, QoS information equivalent to the signal transmitted from the second terminal; receiving, by the second device, QoS satisfaction information indicating whether to satisfy QoS of the first terminal from the first device; and performing intercell interference coordinating based on the QoS information received by the second device from the second terminal and the QoS satisfaction information received from the first device.

Here, the performing may include changing, by the second device, a wireless resource for signal transmission when the QoS satisfaction information indicates QoS satisfaction and the QoS information does not satisfy a predetermined second criterion.

Also, the performing may include reducing, by the second device, a transmission power when the QoS satisfaction information indicates QoS dissatisfaction and the QoS information satisfies a predetermined second criterion.

In addition, the performing may include minimizing, by the second device, a transmission power or changing, by the second device, a wireless resource for signal transmission when the QoS satisfaction information indicates QoS dissatisfaction and the QoS information does not satisfy a predetermined second criterion.

In other example embodiments, a wireless communication system including a first cell and a second cell which are interfered by each other, including: a first device that operates the first cell, transmits a signal to a first terminal through beamforming, and transmits QoS satisfaction information based on first QoS information fed back from the first terminal; and a second device that operates the second cell, transmits a signal to a second terminal through beamforming, and performs intercell interference coordinating based on second QoS information fed back from the second terminal and the QoS satisfaction information.

Here, the first device may perform beamforming on the first terminal using an MRT beamforming vector calculated based on channel information between the first device and the first terminal, and the second device may perform beamforming on the second terminal using an MRT beamforming vector calculated based on channel information between the second device and the second terminal.

Here, each of the first QoS information and the second QoS information may include at least one of received SNR information and an amount of data transfer.

In addition, the second device may change a wireless resource for transmitting a signal to the second terminal when the QoS satisfaction information indicates QoS satisfaction and the second QoS information does not satisfy a predetermined criterion.

In addition, the second device may reduce a transmission power when the QoS satisfaction information indicates QoS dissatisfaction and the second QoS information satisfies a predetermined criterion, and minimize the transmission power or change a wireless resource for transmitting a signal to the second terminal when the QoS satisfaction information indicates QoS dissatisfaction and the QoS information does not satisfy the predetermined criterion.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a method for coordinating intercell interference in a heterogeneous network environment in which a macro-cell and a femto-cell are overlapped;

FIG. 2 is a flowchart illustrating a method for coordinating intercell interference according to an embodiment of the present invention;

FIG. 3 is a diagram illustrating a parameter applied for performance estimation of intercell interference coordinating according to an embodiment of the present invention; and

FIG. 4 is a graph illustrating a performance estimation result of intercell interference coordinating according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention. Example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

With reference to the appended drawings, exemplary embodiments of the present invention will be described in detail below. To aid in understanding the present invention, like numbers refer to like elements throughout the description of the figures, and the description of the same elements will be not reiterated.

“Terminal” used in the present application may be referred to as various terms such as a mobile station (MS), a mobile terminal (MT), a user terminal, a user equipment (UE), a user terminal (UT), a wireless terminal, an access terminal (AT), a subscriber unit, a subscriber station (SS), a wireless device, a wireless communication device, a wireless transmit/receive unit (WTRU), a mobile node, a mobile, and the like, and “base station” used in the present application may be referred to as various terms such as a base station, a Node-B, an eNode-B, a base transceiver system (BTS), an access point, a point, and the like.

In addition, in the following descriptions, “femto-cell base station” may be referred to as various terms such as a ultra-small base station, a small base station, an indoor base station, an indoor base station, a ultra-small wireless connector, Home NodeB (HNB), Home eNodeB (HeNB), Femto-cell Base Station (FBS), Femto Access Point (FAP), Base Transceiver Station (Femto BTS), WiBro/WiMax Femto Access Point (WFAP), and the like. In addition, the femto-cell may refer to a cell operated by a femto-cell base station, and a single femto-cell base station may operate at least one femto-cell. In the following descriptions, the terms of femto-cell base station and femto-cell may be interchangeably used, but a femto-cell should be understood to refer to a femto-cell base station unless specifically mentioned.

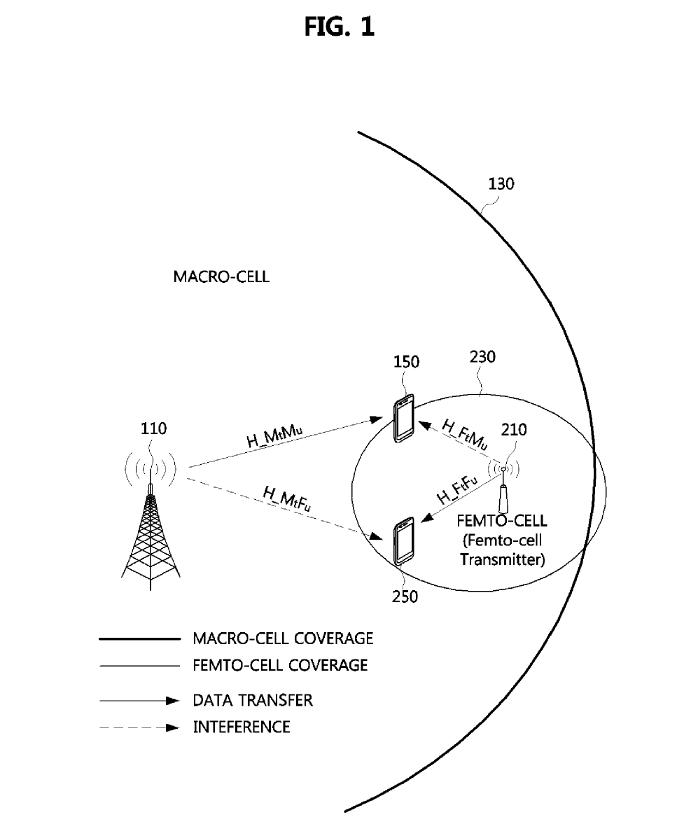

FIG. 1 is a conceptual diagram illustrating a method for coordinating intercell interference in a heterogeneous network environment in which a macro-cell and a femto-cell are overlapped.

Referring to FIG. 1, in a heterogeneous network environment (or interference channel (IFC) network) in which a femto-cell 230 operated by a femto-cell base station 210 is overlapped within a coverage of a macro-cell 130 operated by a macro-cell base station 110, a macro-cell terminal 150 and a femto-cell terminal 250 which are located in a boundary of the macro-cell 130 and the femto-cell 230 may be interfered with by signals transmitted from a base station of a communicating party that is not their own serving base station.

That is, the macro-cell terminal 150 is interfered with by signals transmitted from the femto-cell base station 210, and the femto-cell base station 210 is interfered with by signals transmitted from the macro-cell base station 110.

The most common method for coordinating intercell interference in the network environment shown in FIG. 1 is a method in which beamforming may be designed using all channel information between a transmission device (for example, the macro-cell base station 110 and the femto-cell base station 210) and a reception device (for example, the macro-cell terminal 150 and the femto-cell terminal 250), and the designed beamforming may be used in the transmission device.

Hereinafter, a method that designs beamforming for coordinating intercell interference will be described with reference to FIG. 1.

In FIG. 1, when it is assumed that a channel between the macro-cell base station 110 and the macro-cell terminal 150 is H_MtMu, a channel between the femto-cell base station 210 and the femto-cell terminal 250 is H_FtFu, a channel between the macro-cell base station 110 and the femto-cell terminal 250 is H_MtFu, and a channel between the femto-cell base station 210 and the macro-cell terminal 150 is H_FtMu, and all information of the above-described channels is used, design of beamforming (B_Macro) of the macro-cell 130 and beamforming (B_Femto) of the femto-cell 230 may be configured with a Zero Forcing (ZF) vector and a Maximum Ratio Transmission (MRT) as shown in the following Equation 1.

B_Femto=α₁·ZF_{Femto}+β₁·MRT_{Femto}

B_Macro=α₂·ZF_{Macro}+β₂·MRT_{Macro}

α₁+β₁=α₂+β₂=1 [Equation 1]

In Equation 1, a denotes a constant for adjusting an amount of data transfer, and β denotes a constant for adjusting effect of interference. In addition, α₁+β₁=α₂+β₂=1 is set based on a power mean value of the transmission device.

The ZF vector and MRT vector included in Equation 1 may be calculated through the following Equation 2.

MRT_{Femto}=H_{—}FtMu/norm(H_{—}FtMu)

Z̅F̅_{Femto}=(H_{—}FtFu′−(MRT_{Femto}′·H_{—}FtFu′)·MRT_{Femto})

ZF_{Femto}= Z̅F̅_{Femto}/norm( Z̅F̅_{Femto})

MRT_{Macro}=H_{—}MtFu/norm(H_{—}MtFu)

Z̅F̅_{Macro}=(H_{—}MtMu′−(MRT_{Macro}′·H_{—}MtMu′)·MRT_{Macro})

ZF_{Macro}= Z̅F̅_{Macro}/norm( Z̅F̅_{Macro}) [Equation 2]

In Equation 2, norm denotes a norm value of a corresponding channel vector, and ′ denotes a conjugate transpose of a corresponding vector.

In Equations 1 and 2, a channel direction in which interference is caused is set as MRT, and a direction perpendicular to an interference direction is set as ZF.

In addition, effect of the interference may be adjusted by adjusting β, and an amount of data transfer may be adjusted by adjusting α.

When using the above-described beamforming method, an amount of data transfer may be improved while adjusting an amount of interference affecting a corresponding terminal.

However, the above-described beamforming method has a problem that design of the beamforming may be possible only when the transmission device should be aware of all channel information.

In an actual network environment such as LTE or the like, channel information between the macro-cell terminal 150 and the femto-cell base station 210 and channel information between the femto-cell terminal 250 and the macro-cell base station 110 may not be used unless a separate new protocol is provided. Accordingly, the above-described method of designing beamforming is difficult to be practically applied.

In the method for coordinating intercell interference according to an embodiment of the present invention, in order to solve the above-described problem, a method for coordinating intercell interference based on an actual network environment where interference channel information cannot be known is provided.

Hereinafter, a method for coordinating intercell interference according to an embodiment of the present invention will be described.

In the method for coordinating intercell interference according to an embodiment of the present invention, it is assumed that a channel H_FtMu between the macro-cell terminal 150 and the femto-cell base station 210 which is an interference channel in the network environment shown in FIG. 1 and a channel H_MtFu between the femto-cell terminal 250 and the macro-cell base station 110 are unknown, and beamforming of the transmission device may be designed only using a channel H_MtMu between the macro-cell base station 110 and the macro-cell terminal 150 and a channel H_FtFu between the femto-cell base station 210 and the femto-cell terminal 250.

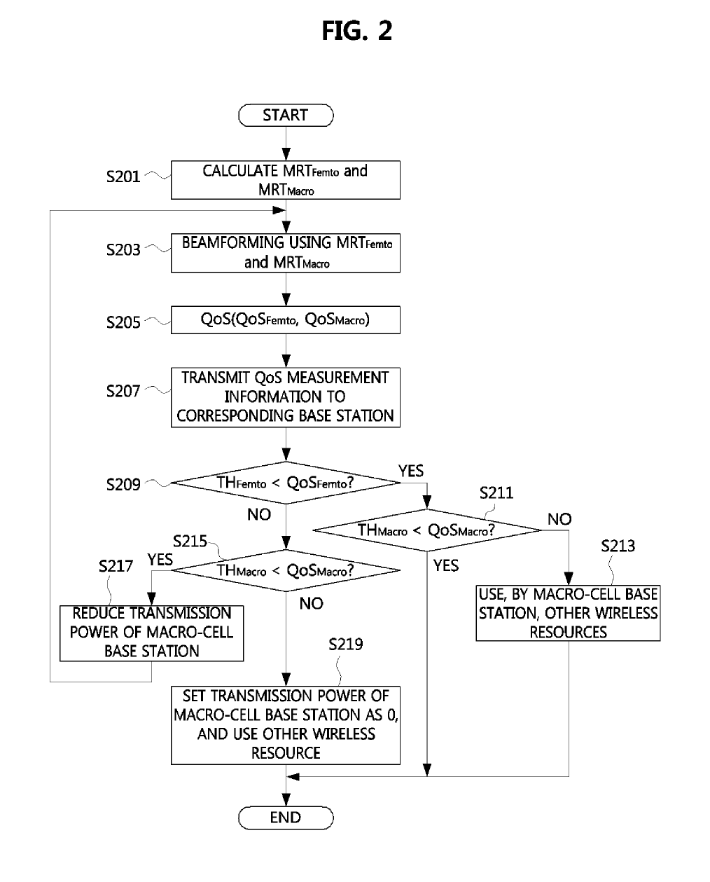

FIG. 2 is a flowchart illustrating a method for coordinating intercell interference according to an embodiment of the present invention.

Referring to FIG. 2, in step S201, the macro-cell base station 110 and the femto-cell base station 210 respectively calculate MRT vectors MRT_{Macro} and MRT_{Femto} using Equation 1.

Here, the macro-cell base station 110 calculates the MRT vector MRT_{Macro} using channel information between the macro-cell base station 110 and the macro-cell terminal 150, and the femto-cell base station 210 calculates the MRT vector MRT_{Femto} using channel information H_FtFu between the femto-cell base station 210 and the femto-cell terminal 250. Each of the base stations 110 and 210 may transmit a reference signal for channel measurement, and a corresponding terminal may measure the transmitted reference signal to report the measured signal to corresponding base stations 110 and 210, and therefore each of the base stations 110 and 210 may know the above-described channel information H_MtMu and H_FtFu.

Next, in step S203, the macro-cell base station 110 transmits a signal to the femto-cell terminal 250 by performing beamforming using the calculated MRT vector MRT_{Macro}, and the femto-cell base station 210 transmits a signal to the femto-cell terminal 250 by performing beamforming using the calculated MRT vector MRT_{Femto}.

In step S205, the macro-cell terminal 150 receives the signal transmitted from the macro-cell base station 110 and measures Quality of Service (QoS) of the received signal, and the femto-cell terminal 250 receives the signal transmitted from the femto-cell base station 210 and measures QoS of the received signal.

Here, QoS may be measured by various methods. For example, QoS may be measured by an amount of data transfer equivalent to a received Signal to Noise Ratio (SNR) value of the signals received by each terminal.

Otherwise, the received SNR value may be used as a QoS measurement criterion.

Next, in step S207, the macro-cell terminal 150 transmits the measured QoS information QoS_{macro} to the macro-cell base station 110 that is the macro-cell terminal's own serving base station, and the femto-cell terminal 250 transmits the measured QoS information QoS_{femto} to the femto-cell base station 210.

In step S209, the femto-cell base station 210 compares the QoS information QoS_{femto} received from the femto-cell terminal 250 and a predetermined threshold value with respect to QoS of the femto-cell terminal 250 to thereby determine whether QoS of the femto-cell terminal 250 satisfies a predetermined criterion.

When the QoS of the femto-cell terminal 250 satisfies the predetermined criterion, the femto-cell base station 210 notifies QoS satisfaction information to the macro-cell base station 110. Here, the femto-cell base station 210 may notify the QoS satisfaction information to the macro-cell base station 110 through a backhaul link.

In step S211, the macro-cell base station 110 that has received the QoS satisfaction information from the base station 210 compares the QoS information QoS_{macro} received from the macro-cell terminal 150 and a predetermined threshold value TH_{macro} with respect to QoS of the macro-cell terminal 150 to thereby determine whether the QoS of the macro-cell terminal 150 satisfies a predetermined criterion.

When the QoS of the macro-cell terminal 150 satisfies the predetermined criterion, both the femto-cell terminal 250 and the macro-cell terminal 150 satisfies the QoS criterion, and therefore the method for coordinating intercell interference may be completed.

Meanwhile, in step S213, when the QoS of the macro-cell terminal 150 does not satisfy the predetermined criterion based on the determined result in step S211, the macro-cell base station 110 may use other wireless resources so as to satisfy the QoS criterion while avoiding the interference with the femto-cell 230.

In addition, when the QoS of the femto-cell terminal 250 does not satisfy the predetermined criterion based on the determination result in step S209, the femto-cell base station 210 transmits QoS dissatisfaction information to the macro-cell base station 110.

In step S215, the macro-cell base station 110 receives the QoS dissatisfaction information from the femto-cell base station 210, and compares the QoS information received from the macro-cell terminal 150 and a predetermined threshold value TH_{macro} with respect to QoS of the macro-cell terminal 150 to thereby determine whether the QoS of the macro-cell terminal 150 satisfies a predetermined criterion.

In step S217, when the QoS of the macro-cell terminal 150 satisfies the predetermined criterion, the macro-cell base station 110 adjusts interference with the femto-cell 230 by reducing a transmission power in accordance with a predetermined criterion.

That is, in the method for coordinating intercell interference according to an embodiment of the present invention, when the QoS of the femto-cell terminal 250 does not satisfy the predetermined criterion and the QoS of the macro-cell terminal satisfies the predetermined criterion, it is possible to adjust effect of interference exerted on the femto-cell terminal 250 by reducing a transmission power of the macro-cell 130.

In step S219, when the QoS of the macro-cell terminal 150 does not satisfy the predetermined criterion in step S215 (that is, when both the femto-cell terminal 250 and the macro-cell terminal 150 do not satisfy the QoS criterion), the macro-cell base station 110 sets a transmission power as 0 and may use a wireless resource different from a wireless resource (for example, frequency) that is currently allocated.

In FIG. 2, an example in which intercell interference is coordinated while QoS of the femto-cell 230 is preferentially ensured in an environment in which the macro-cell 130 and the femto-cell 230 are overlapped is illustrated.

For example, as shown in steps S211 and S213 of FIG. 2, when only the QoS of the femto-cell terminal 250 satisfies the predetermined QoS criterion, and the QoS of the macro-cell terminal 150 does not satisfy the predetermined QoS criterion, in the method for coordinating intercell interference according to an embodiment of the present invention, the macro-cell base station 110 uses other wireless resources.

Meanwhile, when the QoS of the femto-cell terminal 250 satisfies the QoS criterion and the QoS of the macro-cell terminal 150 does not satisfy the QoS criterion, it is possible to preferentially consider the QoS of the macro-cell 130 by reducing a transmission power of the femto-cell 230. However, when the QoS of the macro-cell 130 is preferentially considered, there is a problem that an amount of data transfer of the femto-cell terminal 250 is reduced. Accordingly, in the method for coordinating intercell interference according to an embodiment of the present invention, in the above-described case, the macro-cell base station 110 transmits signals using other wireless resources (for example, frequency), and therefore amounts of data transfer of all of the macro-cell 130 and the femto-cell 230 may be maintained.

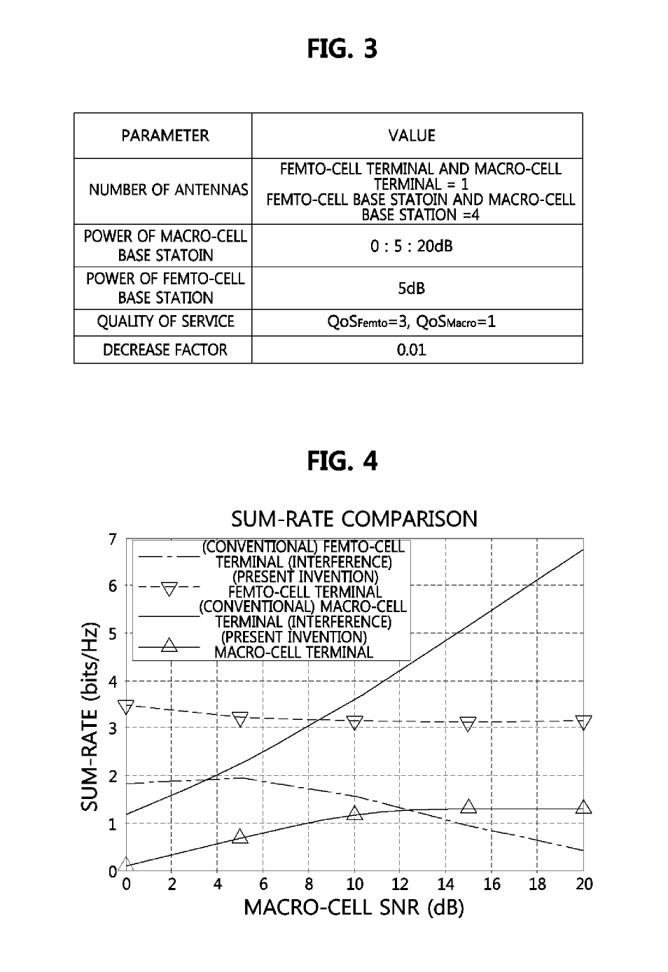

FIG. 3 is a diagram illustrating a parameter applied for performance estimation of intercell interference coordinating according to an embodiment of the present invention, and FIG. 4 is a graph illustrating a performance estimation result of intercell interference coordinating according to an embodiment of the present invention.

First, referring to FIG. 3, performance estimation of intercell interference coordinating according to an embodiment of the present invention is performed by comparing the conventional method for coordinating intercell interference in which the femto-cell base station 210 and the macro-cell base station 110 perform beamforming using all channel information including an interference channel in the network disposition environment shown in FIG. 1 and a sum-rate of each terminal in accordance with a power change (Macro-cell SNR) of the macro-cell base station 110.

In addition, in the performance estimation, it is assumed that each of the femto-cell terminal 250 and the macro-cell terminal 150 includes a single antenna and each of the femto-cell base station 210 and the macro-cell base station 110 includes four antennas. In addition, in a state in which a transmission power of the macro-cell 130 is changed to 0˜20 dB with 5 dB step and a transmission power of the femto-cell 230 is fixed as 5 dB, performance estimation is performed.

As shown in FIG. 4, in the conventional method for coordinating intercell interference, the signal transmitted from the macro-cell base station 110 interferes the femto-cell terminal 250 along with an increase in the transmission power (Macro-cell SNR) of the macro-cell base station 110, thereby reducing Qos of the femto-cell terminal 250.

However, in the method for coordinating intercell interference according to an embodiment of the present invention, even when the transmission power of the macro-cell base station 110 increases, intercell interference may be coordinated by preferentially considering the QoS of the femto-cell terminal 250, and therefore the QoS of the femto-cell terminal 250 may be ensured.

In addition, in the method for coordinating intercell interference according to an embodiment of the present invention, the QoS of the femto-cell terminal 250 may be ensured by preferentially considering the QoS of the femto-cell terminal 250 as described above, and intercell interference may be coordinated by changing a wireless resource with respect to the macro-cell terminal 150, as necessary, thereby also satisfying the QoS of the macro-cell terminal 150.

That is, in the method for coordinating intercell interference according to an embodiment of the present invention, even when information about channels interfered with each other is not known in a network disposition environment in which the macro-cell 130 and the femto-cell 230 are overlapped with each other, an MRT vector may be configured using only obtainable channel information, beamforming may be performed using the configured MRT vector, and an MRT beamforming power may be adjusted based on QoS information fed back from each terminal, thereby effectively coordinating intercell interference.

In addition, the macro-cell may perform intercell interference coordinating by preferentially considering the QoS of the femto-cell, and therefore amounts of data transfer of both the macro-cell and the femto-cell may be maintained, thereby satisfying all QoS.

While the example embodiments of the present invention and their advantages have been described in detail, it should be understood that various changes, substitutions and alterations may be made herein without departing from the scope of the invention.

What is claimed is:

1. A method for coordinating intercell interference between a first cell operated by a first device and a second cell operated by a second device, the method comprising:
calculating, by the first device, a beamforming vector;
transmitting a signal to a first terminal using the beamforming vector calculated by the first device;
receiving, by the first device, Quality of Service (QoS) information equivalent to the signal transmitted from the first terminal; and
determining whether the QoS information received by the first device satisfies a predetermined first criterion and transmitting information indicating whether QoS is satisfied to a first base station.

2. The method according to claim 1, wherein the calculating includes calculating a Maximum Ratio Transmission (MRT) vector only using channel information between the first device and the first terminal except information of a channel in which interference is caused by the first device.

3. The method according to claim 1, wherein the first cell is disposed so as to be overlapped with the second cell, and the first device operates the first cell with power lower than that of the second device.

4. The method according to claim 1, wherein the receiving includes receiving at least one of received single-to-noise ratio (SNR) information and an amount of data transfer from the first terminal.

5. A method for coordinating intercell interference between a first cell operated by a first device and a second cell operated by a second device, the method comprising:
calculating, by the second device, a beamforming vector;
transmitting a signal to a second terminal using the beamforming vector calculated by the second device;
receiving, by the second device, QoS information equivalent to the signal transmitted from the second terminal;
receiving, by the second device, QoS satisfaction information indicating whether to satisfy QoS of the first terminal from the first device; and
performing intercell interference coordinating based on the QoS information received by the second device from the second terminal and the QoS satisfaction information received from the first device.

6. The method according to claim 5, wherein the calculating includes calculating an MRT vector only using channel information between the second device and the second terminal except information of a channel in which interference is caused by the second device.

7. The method according to claim 5, wherein the receiving of the QoS information includes receiving at least one of received SNR information and an amount of data transfer from the second terminal.

8. The method according to claim 5, wherein the performing includes changing, by the second device, a wireless resource for signal transmission when the QoS satisfaction information indicates QoS satisfaction and the QoS information does not satisfy a predetermined second criterion.

9. The method according to claim 5, wherein the performing includes reducing, by the second device, a transmission power when the QoS satisfaction information indicates QoS dissatisfaction and the QoS information satisfies a predetermined second criterion.

10. The method according to claim 5, wherein the performing includes minimizing, by the second device, a transmission power or changing, by the second device, a wireless resource for signal transmission when the QoS satisfaction information indicates QoS dissatisfaction and the QoS information does not satisfy a predetermined second criterion.

11. A wireless communication system including a first cell and a second cell which are interfered by each other, comprising:
a first device that operates the first cell, transmits a signal to a first terminal through beamforming, and transmits QoS satisfaction information based on first QoS information fed back from the first terminal; and
a second device that operates the second cell, transmits a signal to a second terminal through beamforming, and performs intercell interference coordinating based on second QoS information fed back from the second terminal and the QoS satisfaction information.

12. The wireless communication system according to claim 11, wherein the first device performs beamforming on the first terminal using an MRT beamforming vector calculated based on channel information between the first device and the first terminal, and the second device performs beamforming on the second terminal using an MRT beamforming vector calculated based on channel information between the second device and the second terminal.

13. The wireless communication system according to claim 11, wherein each of the first QoS information and the second QoS information includes at least one of received SNR information and an amount of data transfer.

14. The wireless communication system according to claim 10, wherein the second device changes a wireless resource for transmitting a signal to the second terminal when the QoS satisfaction information indicates QoS satisfaction and the second QoS information does not satisfy a predetermined criterion.

15. The wireless communication system according to claim 10, wherein the second device reduces a transmission power when the QoS satisfaction information indicates QoS dissatisfaction and the second QoS information satisfies a predetermined criterion, and minimizes the transmission power or changes a wireless resource for transmitting a signal to the second terminal when the QoS satisfaction information indicates QoS dissatisfaction and the QoS information does not satisfy the predetermined criterion.
